(19) United States
(12) Patent Application Publication
(10) Pub. No.: US 2007/0151908 A1
(43) Pub. Date: Jul. 5, 2007

(54) Vertical well for fluid circulation

(76) Inventors: Shyang-Hua Lu, Tainan City (TW); Yu-Hua Lu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,696

(22) Filed: Dec. 30, 2005

(51) Int. Cl. C02F 1/00

(52) U.S. Cl. 210/170.07

(57) ABSTRACT

The present invention provides a vertical well for fluid circulation. The vertical well comprises a separation wall for splitting said vertical well into an inlet tunnel and an outlet tunnel, a connection tunnel in the bottom of said vertical well for interconnecting said inlet tunnel and said outlet tunnel, and a air leakage system laid at the bottom of said vertical well for providing air flow to said outlet tunnel.

### BACKGROUND OF THE INVENTION

1. Field of the Invention

The present invention generally relates to well structure, and more particularly to vertical well for fluid circulation.

2. Description of the Prior Art

Aquatic products, such as fishes, shrimps, and shells, need fresh water and oxygen to survive in the breeding pools. Conventionally, surface propellers are used to splash air into water and help to circulate the water. In addition, air pumps are also used to pump air to increase oxygen dissolving rate in the water.

However, the surface propellers make a lot of noise that may disturb the growth of aquatic products since some species are very sensitive to disturbance. The air leakage pipelines of air pumps are usually placed besides the aquatic products. Pumped air bubbles may also influence the growth of aquatic products.

In summarized, there exists a need to have a new invention to help fluid circulation and oxygen dissolving.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

One object of the present invention is to provide a vertical well for fluid circulation. The vertical well comprises a separation wall for splitting said vertical well into an inlet tunnel and an outlet tunnel, a connection tunnel in the bottom of said vertical well for interconnecting said inlet tunnel and said outlet tunnel, and a air leakage system laid at the bottom of said vertical well for providing air flow to said outlet tunnel.

Another object of the present invention is to provide a fluid circulation system, which comprises a plurality of vertical wells, with each having an inlet tunnel and an outlet tunnel for sucking in and pumping out fluid, for fluid circulation in a pool. Water pumped out of one of said plurality of vertical wells would be sucked into another of said plurality of vertical wells.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates a circulation system of an embodiment in accordance with the present invention;

FIG. 2A and FIG. 2B are diagrams depict the vertical well; and

FIG. 3A to 3C are diagrams show top views of a circulation system of another embodiment in accordance with the present invention.

### DETAILED DESCRIPTION OF THE PREFERRED EMBODIMENTS.

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

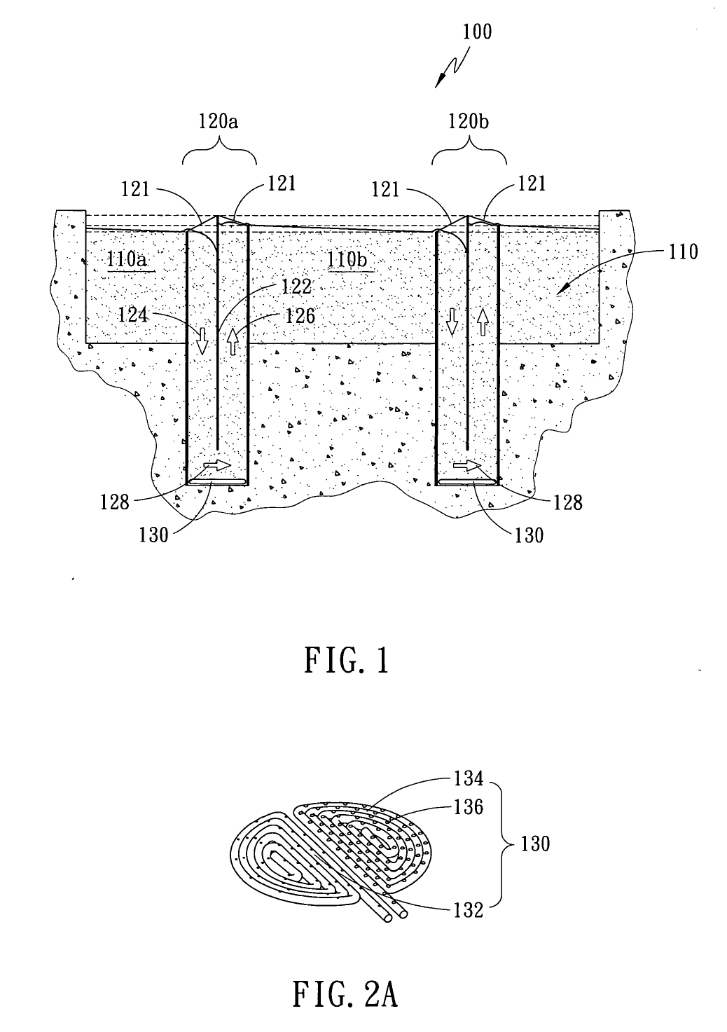

Please refer to FIG. 1, which is a diagram shows a circulation system 100 of an embodiment in accordance with the present invention. This circulation system 100 comprises a plurality of vertical wells 120 of a pool 110. In this regards, each vertical wells 120 comprises a separation wall 122 for splitting the vertical wells 120 into an inlet tunnel 124 and an outlet tunnel 126, a connection tunnel 128 in the bottom of the vertical well 120 for interconnecting the inlet tunnel 124 and outlet tunnel 126, and an air leakage system 130 laid at the bottom of the vertical well 120 for providing air flow to the outlet tunnel 126.

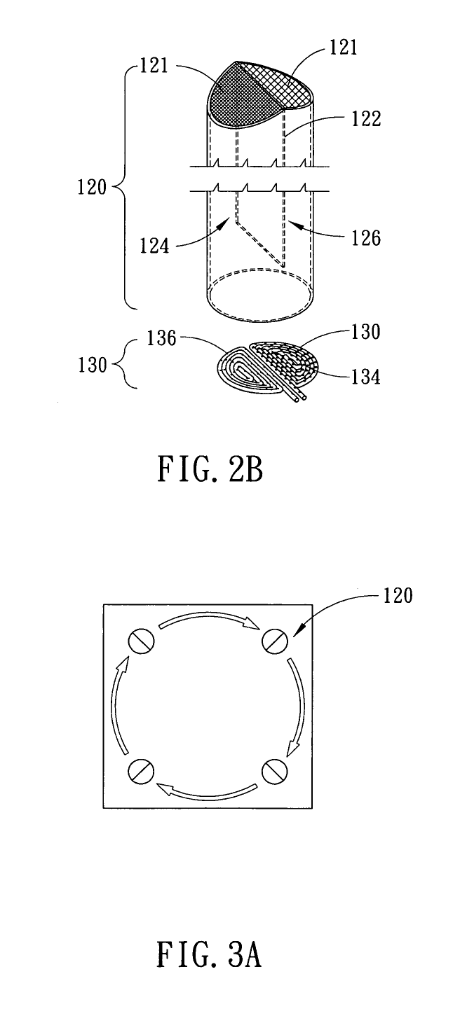

Please refer to FIG. 2A and FIG. 2B, which are diagrams show the vertical well 120. As shown in the FIG. 2A, the air leakage system 130, which is configured to leak normal air or oxygen gas, comprises at least one inlet pipe 132 in the bottom of the inlet tunnel 124 and at least one outlet pipe 134 in the bottom of the outlet tunnel 126. The inlet pipe 132 as well as the outlet pipe 134 comprises a lot of air leakage holes 136 for leaking air into the inlet tunnel 124 as well as the outlet tunnel 126. However, it is designated that the leaked air flow of the outlet pipe 134 is larger than the leaked air flow of the inlet pipe 132. In one example of this embodiment, the leakage holes 136 of the outlet pipe 134 are larger than those leakage holes 136 of the inlet pipe 132. In another example of this embodiment, the number of leakage holes 136 of the outlet pipe 134 is larger than the number of leakage holes 136 of the inlet pipe 132. Please note that the present invention does not constrain the number of inlet pipe 132 and outlet pipe 134 as long as the air flow leaked to the outlet tunnel 126 is larger than to the inlet tunnel 124. The difference of leaked air flows between the inlet tunnel 124 and the outlet tunnel 126 creates a suction force from the inlet tunnel 124 to the outlet tunnel 126. Therefore water in the pool 110 would be sucked into the inlet tunnel 124, flowed through the connection tunnel 128 in the bottom of the vertical well 120, and pumped out of the outlet tunnel 126 into the pool 110. The dynamics would not only help fluid circulation but also increase oxygen dissolving rate.

Now back to the FIG. 1, the fluid flow could be explained in detail. Since water at a first portion 110a of the pool 110 would be sucked into a first vertical well 120a, the water level of the first portion 110a is descendent gradually to the opening of the inlet tunnel 124. Water level of the opening of the inlet tunnel 124 is the lowest in the pool 110. Because water would be pumped out of the outlet tunnel 126, water level of the opening of the outlet tunnel 126 would be the highest in the pool 110. In addition, the separation wall 122 of the vertical well 120 should be high enough to prevent water overflowed from the outlet tunnel 126 back into the inlet tunnel 124. Similarly, the water level at a second portion 110b of the pool is also descendent gradually to another inlet tunnel 124 of a second vertical well 120b. In this regards, the opening of the inlet tunnel 124 should be lower than the average water level; in the other hands, the opening of the outlet tunnel 126 should be higher than the average water level. Besides, in order to prevent foreign objects or aquatic products are sucked into the inlet tunnel 124, the opening of the vertical well 120 may comprise a filter or a grid 121 for safety.

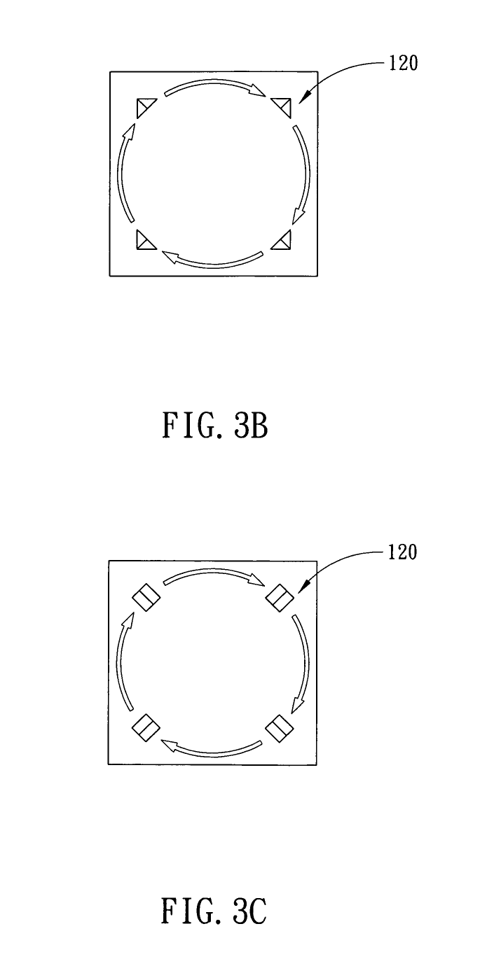

Please refer to the FIG. 3A to 3C, which show diagrams of top views of a circulation system 100 of another embodiment in accordance with the present invention. In a square shape of pool 110, four vertical wells 120 are placed near four corners of the pool 110. Each vertical well 120 is configured to suck water from one edge and bump water to another edge around the occupied corner clockwise or counter-clockwise. Therefore water in this pool 110 would be circulated clockwise or counter-clockwise. In the FIG. 3A, the shape of the opening of the vertical well 120 is a circle or an ellipse. In the FIG. 3B, the shape of the opening of the vertical well 120 is a triangle. And the shape of opening of the vertical well 120 in the FIG. 3C is a square or a rectangle. Please note that the present invention does not constrain the shape of the opening of the vertical well 120.

In this present invention, the suction force is proportional to the depth of the vertical well 120. However, pumping force required by the air leakage system 130 is also proportional to the depth of the vertical well 120. In an example, the depth of the vertical well 120 is more than 2.5 meter.

In summarized, the circulation system 100 disclosed in this invention does not only help circulation but also increase oxygen dissolving rate of the pool 110.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A vertical well for fluid circulation, comprising:
a separation wall for splitting said vertical well into an inlet tunnel and an outlet tunnel;
a connection tunnel in the bottom of said vertical well for interconnecting said inlet tunnel and said outlet tunnel; and
a air leakage system laid at the bottom of said vertical well for providing air flow to said outlet tunnel.

2. The vertical well of claim 1, wherein said air leakage system further comprising:
at least one inlet pipe having a plurality of air leakage holes for leaking air into said inlet tunnel; and at least one outlet pipe having a plurality of air leakage holes for leaking air into said outlet tunnel;
wherein air flow leaked to said outlet tunnel is larger than to said inlet tunnel.

3. The vertical well of claim 1, wherein said separation wall is high enough to prevent water overflowed from said outlet tunnel back into said inlet tunnel.

4. The vertical well of claim 1, wherein the opening of the vertical well comprising one or any combination of the followings:
a filter; and
a grid.

5. The vertical well of claim 1, wherein the opening of said outlet tunnel is higher than the opening of said inlet tunnel.

6. The vertical well of claim 1, wherein the shape of the opening of said vertical well comprising one of the followings:
a circle;
an ellipse;
a triangle;
a square; and
a rectangle.

7. The vertical well of claim 1, wherein the depth of said vertical well is 2.5 meter.

8. The vertical well of claim 1, wherein leaking gas of said air leakage system comprising oxygen.

9. A fluid circulation system, comprising:
a plurality of vertical wells, with each having an inlet tunnel and an outlet tunnel for sucking in and pumping out fluid, for fluid circulation in a pool; and
wherein water pumped out of one of said plurality of vertical wells would be sucked into another of said plurality of vertical wells.

10. The fluid circulation system of claim 9, wherein each of said vertical well comprising:
a separation wall for splitting said vertical well into said inlet tunnel and said outlet tunnel;
a connection tunnel in the bottom of said vertical well for interconnecting said inlet tunnel and said outlet tunnel; and
a air leakage system laid at the bottom of said vertical well for providing air flow to said outlet tunnel.

11. The fluid circulation system of claim 10, wherein said air leakage system further comprising:
at least one inlet pipe having a plurality of air leakage holes for leaking air into said inlet tunnel; and
at least one outlet pipe having a plurality of air leakage holes for leaking air into said outlet tunnel;
wherein air flow leaked to said outlet tunnel is larger than to said inlet tunnel.

12. The fluid circulation system of claim 10, wherein said separation wall is high enough to prevent water overflowed from said outlet tunnel back into said inlet tunnel.

13. The fluid circulation system of claim 10, wherein the opening of the vertical well comprising one or any combination of the followings:
a filter; and
a grid.

14. The fluid circulation system 1 of claim 9, wherein the opening of said outlet tunnel is higher than the opening of said inlet tunnel.

15. The fluid circulation system of claim 9, wherein the shape of the opening of said vertical well comprising one of the followings:
a circle;
an ellipse;
a triangle;
a square; and
a rectangle.

16. The fluid circulation system of claim 9, wherein the depth of said vertical well is 2.5 meter.

17. The fluid circulation system of claim 10, wherein leaking gas of said air leakage system comprising oxygen.
